(19) United States
(12) Patent Application Publication
(10) Pub. No.: US 2007/0192012 A1
(43) Pub. Date: Aug. 16, 2007

(54) Method and system of enhanced vehicle road speed limiting

(75) Inventor: Dennis Michael Letang, Canton, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Detroit Diesel Corporation

(21) Appl. No.: 11/353,699

(22) Filed: Feb. 14, 2006

(51) Int. Cl. B60T 8/32

(52) U.S. Cl. 701/93; 180/170

(57) ABSTRACT

A method and system for controlling a compression ignition electronic control module equipped compression ignition internal combustion engine installed in a vehicle to provide enhanced vehicle road speed limiting to conform to requirements of a geographical location.

### BACKGROUND OF THE INVENTION

1. Field of the Invention

The present invention relates to a method of enhanced vehicle road speed limiting, wherein an engine equipped with an electronic control unit (ECU) receives a signal indicating its geographic location and would conform its engine fueling routines to limit vehicle road speed to the requirements of the particular geographical location.

The present invention further relates to a method of enhanced vehicle road speed limiting. The invention limits a vehicle's road speed in states that require vehicle road speed limits, but allows unrestricted vehicle operation in states that do not restrict vehicle road speed limits. It is contemplated that the vehicle could identify its location through means of a global positioning system and by use of a look-up table, implement the particular fueling or governor strategy to limit the vehicle road speed to that required by the laws of that state.

The present invention further relates to a method to provide for an external communication system such as a satellite tracking system to communicate to the vehicle its geographical location. Engine fueling or governing strategies could then be implemented to limit vehicle road speed based upon geographical location.

The present invention further relates to a method of enhanced vehicle road speed limiting of an internal combustion engine by having the driver communicate to the engine controller the vehicle's geographical location. In each instance, the fueling strategy would be stored in a look-up table that is required to limit vehicle road speed conformable to the requirements of the laws of the particular state in which the vehicle is located. By identifying which state the vehicle is located, the ECU can determine whether vehicle road speed limits are required. If the location requires limiting vehicle road speed during operation, fueling strategies or governor strategies will be implemented to control fuel to the engine thereby limiting the vehicle speed. This vehicle road speed limit could vary from state to state. To handle this, the ECU would, as previously stated, contain a table of fueling strategies to permit vehicle road speed limits as required for each state.

2. Description of the Related Art

Hawkins et al., U.S. Pat. No. 6,814,053 discloses an engine control system that employs a microprocessor base controller to detect engine operation in the speed range previously determined to undesirable, and responding to the detection by changing operation of the engine. In the preferred embodiment, a controller commands a parameter for adjusting engine operation to reach a different speed outside of first and second thresholds defining the undesirable range in a time period subsequent to detection.

Eitzenberger, U.S. Pat. No. 6,023,232 discloses a vehicle communication system and method that includes a central computer for performing data networking applications, individual devices for transmitting, receiving, recording and/or processing data associated with the data networking applications, and one or more data transmission channels with associated interfaces through which the individual devices can be connected with a central vehicle computer. The individual devices are flexibly associated in a controllable fashion with the various data networking applications with an adaptive application control being provided that selects the individual devices on the basis of their functions that are required for performing a given application, and controls the necessary data transmission process.

Olch et al, U.S. Pat. No. 6,377,888 discloses a system for controlling the movement of a free ranging vehicle about a surface. The system enables a vehicle to begin its travel from starting points not known in advance and whose destination point, and thus route, can be changed during the course of travel. The system has at least two dual axis sensors mounted to the vehicle that provide continuous acceleration data, a plurality of tags fixedly arranged about the surface that provide absolute location data; at least two tag readers mounted to the vehicle, each of which reads the absolute location data of the respective tags that the at least two tag readers pass over as the vehicle moves about the surface; and a computer mounted tot he vehicle that functions to receive the absolute location data and the acceleration data and provides corrected motion command signals to the vehicle navigation system that controls the motion of the vehicle.

Kolls, U.S. Pat. No. 6,895,310 discloses an in-vehicle device that communicates with data processing resources, including global networking based data processing resources for the purpose of programming and receiving data from an in-vehicle device where the data communicated can include sampling, intervals, global position system (GPS) data, or scientific instrumentation data related to certain weather, environmental, traffic, or road conditions.

### SUMMARY OF THE INVENTION

Diesel engines have a wide variety of applications including passenger vehicles, marine vessels, earth-moving and construction equipment, stationary generators, and on-highway trucks, among others. Electronic engine controllers provide a wide range of flexibility in tailoring engine performance to a particular application without significant changes to engine hardware. While diesel fuel is often less expensive, and diesel engines are more efficient than gasoline powered engines, operators find it necessary to make runs between destinations as quickly as possible in order to maximize economic return on the vehicle. This economic necessity may conflict with certain speed limiting and vehicle operation regulations of various states that seek to regulate the speed, emissions and particulates released by vehicles operating within their respective borders. In addition, it is a challenge that various states have differing regulations requiring the operator of a vehicle having a regulated engine to adapt to a variety of operating conditions and emission standards, based upon the geographical location of the vehicle at any given time.

In many diesel engine applications, the engine operator does not own the engine, does not understand the environmental regulations in a given geographical location, does not and cannot vary the operation of the engine and does not pay for the fuel or engine maintenance. In addition, operators can receive bonuses and premium payments or other rewards based upon the ability to quickly transport goods from one destination to another. However, the operators may pay for the legal fines associated with vehicle excessive speed. In addition, the operator often seeks maximum speed, power and ease of operation whereas the owner strives to achieve maximum fuel economy and compliance with statutory regulations of which the operator is oftentimes unaware. To further control, engine operation and fuel efficiency, manufacturers have developed and implemented various electronic engine control features that attempt to control engine operation and optimize fuel economy while maintaining acceptable (although often not maximum) power for the particular application and operating conditions. Furthermore, features have been provided that allow the engine owner to impose operational limits on the engine as well as the engine operator to promote safety, fuel economy and compliance with speed and emissions regulations. As such, a system and method of enhanced vehicle road speed limiting to conform operation of the vehicle with speed and environmental regulations in various geographical locations is needed to conform to regulations, improve fuel economy, operator's desire of ease of operation, and to keep the engine running in manner as permitted by regulations in various states through which the vehicle may pass.

Vehicle Road Speed Limiting is an electronic engine control feature designed to limit the fuel available to the engine, thereby controlling and limiting the vehicle road speed. Drivers often attempt to operate vehicles outside acceptable road speed limits in an attempt to maximize individual economic gain. However, such operation may affect fuel economy and expose the driver to unscheduled stops when law enforcement personnel detect such operation. In one implementation of an enhanced method of vehicle road speed limiting, when the engine controller determines that the vehicle is in a geographical location that requires vehicle road speed limiting, the ECM implements fueling strategies that limit vehicle road speed to control the operation of the vehicle within required speed limits. The vehicle road speed limiting automatically takes into account the presence of auxiliary devices in its fueling strategies.

The present invention is a system and method to operate a compression ignition internal combustion engine that will limit vehicle road speed to the requirements of various geographical locations, such as U.S. States, through which the vehicle passes by means of fueling strategies to limit the ability of the engine to operate beyond the vehicle speed limits of the state within which the vehicle is located during actual driving situations.

The present invention is a method to permit the programmable road speed limit and the mandatory road speed limit to change dynamically based upon the geographical location of the vehicle.

### BRIEF DESCRIPTION OF THE DRAWINGS

FIG. 1 is a perspective view of an internal combustion engine incorporating various features of the present invention.

FIG. 2 is a block diagram illustrating a system for implementing an enhanced method of vehicle road speed limiting according to the present invention.

FIG. 3 is a block diagram illustrating operation of a system or method for implementing an enhanced method for vehicle road speed limiting according to the present invention.

### DETAILED DESCRIPTION OF A PREFERRED EMBODIMENT(S)

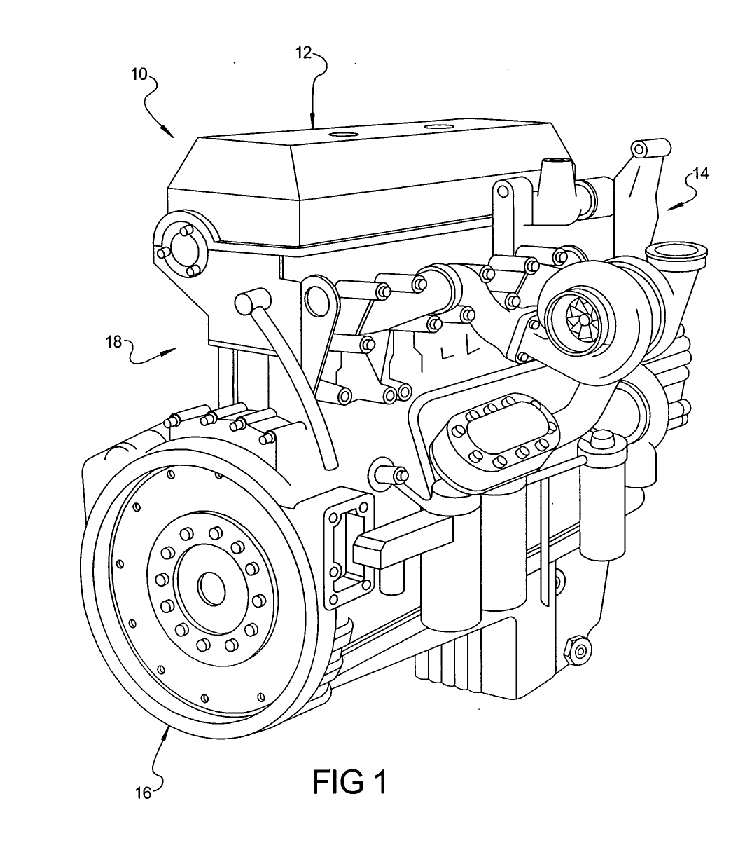

Turning now to the drawings wherein like numbers refer to like structures, and particularly to FIG. 1, there is shown a perspective view of a compression-ignition internal combustion engine 10 incorporating various features according to the present invention. As will be appreciated by those of ordinary skill in the art, engine 10 may be used in a wide variety of applications including on-highway trucks, construction equipment, marine vessels, and stationary generators, among others. Engine 10 includes a plurality of cylinders disposed below a corresponding cover, indicated generally by reference numeral 12. In a preferred embodiment, engine 10 is a multi-cylinder compression ignition internal combustion engine, such as a four, six, eight, twelve, sixteen or twenty-four cylinder diesel engine, for example. Moreover, it should be noted that the present invention is not limited to a particular type of engine or fuel.

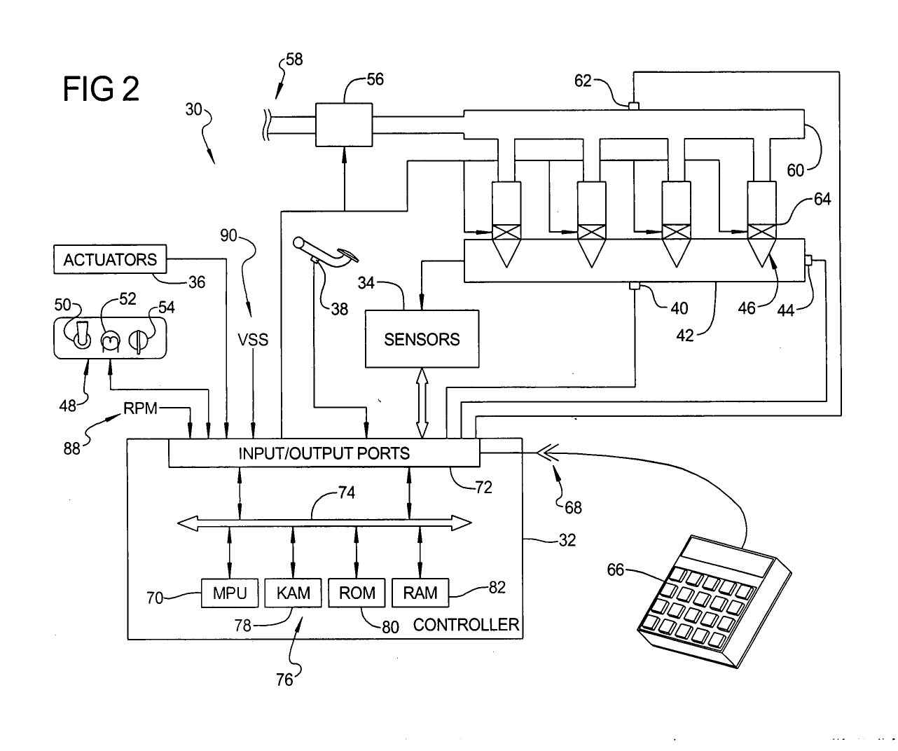

Engine 10 includes an engine control module (ECM) or controller indicated generally by reference numeral 14. ECM 14 communicates with various engine sensors and actuators via associated cabling or wires, indicated generally by reference numeral 18, to control the engine. In addition, ECM 14 communicates with the engine operator using associated lights, switches, displays, and the like as illustrated in greater detail in FIG. 2. The ECM 14 may also have the ability to communicate with Global Positioning Satellites or similar wireless forms of communication such as, but not limited to, satellite tracking systems, wireless internet and driver communications, to review data useful to the operation of the engine. When mounted in a vehicle, engine 10 is coupled to a transmission via flywheel 16. As is well known by those in the art, many transmissions include a power take-off (PTO) configuration in which an auxiliary shaft may be connected to associate auxiliary equipment that is driven by the engine/transmission at a relatively constant rotational speed using the engine's variable speed governor (VSG). Auxiliary equipment may include refrigeration units, air conditioners, and any of a number of other rotationally driven accessories.

Referring now to FIG. 2, a block diagram illustrating a system for idle shutdown override with defeat protection according to the present invention is shown. System 30 represents the control system for engine 10 of FIG. 1. System 30 preferably includes a controller 32 in communication with various sensors 34 and actuators 36. Sensors 34 may include various sensors such as an accelerator position sensor 38. Likewise, sensor 34 may include a coolant temperature sensor 40 that provides an indication of the temperature of engine block 42. Likewise, an oil pressure sensor 44 is used to monitor engine-operating conditions by providing an appropriate signal to controller 32. Other sensors may include rotational sensors to detect the rotational speed of the engine, such as RPM sensor 88 and a vehicle speed sensor (VSS) 90 in some applications. VSS 90 provides an indication of the rotational speed of the output shaft or tail-shaft of a transmission (not shown) that may be used to calculate the vehicle speed. VSS 90 may also represent one or more wheel speed sensors that are used in anti-lock breaking system (ABS) applications, for example.

Actuators 36 include various engine components that are operated via associated control signals from controller 32. As indicated in FIG. 2, various actuators 36 may also provide signal feedback to controller 32 relative to their operational state, in addition to feedback position or other signals used to control actuators 36. Actuators 36 preferably include a plurality of fuel injectors 46 which are controlled via associated solenoids 64 to deliver fuel to the corresponding cylinders. In one embodiment, controller 32 controls a fuel pump 56 to transfer fuel from a source 58 to a common rail or manifold 60. Operation of solenoids 64 controls delivery of the timing and duration of fuel injection as is well known in the art. While the representative control system of FIG. 2 with associated fueling subsystem illustrates the typical application environment of the present invention, the invention is not limited to any particular type of fuel or fueling system.

Sensors 34 and actuators 36 may be used to communicate status and control information to an engine operator via a console 48. Console 48 may include various switches 50 and 54 in addition to indicators 52. Console 48 is preferably positioned in close proximity to the engine operator, such as in the cab of a vehicle. Indicators 52 may include any of a number of audio and visual indicators such as lights, displays, buzzers, alarms, and the like. Preferably, one or more switches, such as switch 50 and switch 54, are used to request a particular operating mode, such as cruise control or PTO mode, for example.

In one embodiment, controller 32 includes a programmed microprocessing unit 70 in communication with the various sensors 34 and actuators 36 via input/output port 72. As is well known by those of skill in the art, input/output ports 72 provide an interface in terms of processing circuitry to condition the signals, protect controller 32, and provide appropriate signal levels depending on the particular input or output device. Processor 70 communicates with input/output ports 72 using a conventional data/address bus arrangement 74. Likewise, processor 70 communicates with various types of computer-readable storage media 76 which may include a non-volatile memory (NVM) 78, a read-only memory (ROM) 80, and a random-access memory (RAM) 82. The various types of computer-readable storage media 76 provide short-term and long-term storage of data used by controller 32 to control the engine. Computer-readable storage media 76 may be implemented by any of a number of known physical devices capable of storing data representing instructions executable by microprocessor 70. Such devices may include PROM, EPROM, BEPROM, flash memory, and the like in addition to various magnetic, optical, and combination media capable of temporary and/or permanent data storage.

Computer-readable storage media 76 include data representing program instructions (software), calibrations, operating variables, and the like used in conjunction with associated hardware to control the various systems and subsystems of the engine and/or vehicle. The engine/vehicle control logic is implemented via controller 32 based on the data stored in computer-readable storage media 76 in addition to various other electric and electronic circuits (hardware).

In one embodiment of the present invention, controller 32 includes control logic to implement fueling strategies to limit vehicle road speed to the regulations required by the geographical location within which the engine is operating. Various methods exist to calculate vehicle road speed, such as are well known to those skilled in the art. For example, calculations based upon wheel size and drive train can be used to arrive at vehicle road speed for a given vehicle. It is contemplated that the controller 32 has data tables that are loaded with fueling strategies that will permit engine operation within calculated speed limits and hence limit vehicle road speed to the requirements of any geographical location. Control logic implemented by controller 32 monitors operating conditions of the engine and/or vehicle to determine the vehicle road speed. Likewise, controller 32 determines the location of the vehicle, whether the geographical location required a hard coded mandatory road speed limit (MRSL), whether the MRSL hard coded in the ECM equal MRSL mandated by the location, whether the road speed limiting feature is enabled, whether the road speed limit equals the minimum programmed roads speed allowed by the geographical location; whether the speed limit equals the minimum or maximum road speed limit and implements the fueling strategy to conform vehicle road speed to the requirements of the geographical location.

Controller 32 then will receive information relative to the geographical location of the engine and will automatically implement fueling strategies to limit vehicle road speed when the road speed exceeds a programmable limit and the engine load is less than a second programmable limit indicating the engine is not being used to drive an auxiliary device. Of course, depending upon the particular application, one or more load thresholds may be utilized to determine whether the engine is being used to drive an auxiliary device.

As used throughout the description of the invention, a selectable or programmable limit or threshold may also be selected by any of a number of individuals via a programming device, such as device 66 selectively connected via an appropriate plug or connector 68 to controller 32. Rather than being primarily controlled by software, the selectable or programmable limit may also be provided by an appropriate hardware circuit having various switches, dials, and the like. Of course, the selectable or programmable limit may also be changed using a combination of software and hardware without departing from the spirit of the present invention.

As described above, compression ignition engines having an enhanced vehicle road speed limiting may be employed to reduce the vehicle speed. However, many engine operators may attempt to defeat this feature to keep the fueling strategies from limiting vehicle speed. As such, the driver “tricks” the engine by selecting an operating mode that does not activate or trigger the vehicle road speed-limiting feature. By selecting an operating mode that is inconsistent with the current operating conditions (no auxiliary device connected), the operator may defeat the implementation of the fueling strategy of the vehicle road speed-limiting feature. According to the present invention, controller 32 determines whether the requested operating mode is inconsistent with the current operating conditions to determine whether to implement the fueling strategies to limit vehicle road speed.

In one embodiment, controller 32 determines whether the requested operating mode is consistent (or inconsistent) with the current operating conditions by comparing the engine load to a selectable or programmable load threshold. If the engine is being used to drive an auxiliary device, the engine will be loaded accordingly. However, if the engine operating conditions indicate that the selected mode of operation is inconsistent or inappropriate, the vehicle road speed-limiting feature will be activated and the fuel delivery to the engine will be limited according to the strategy to limit vehicle road speed.

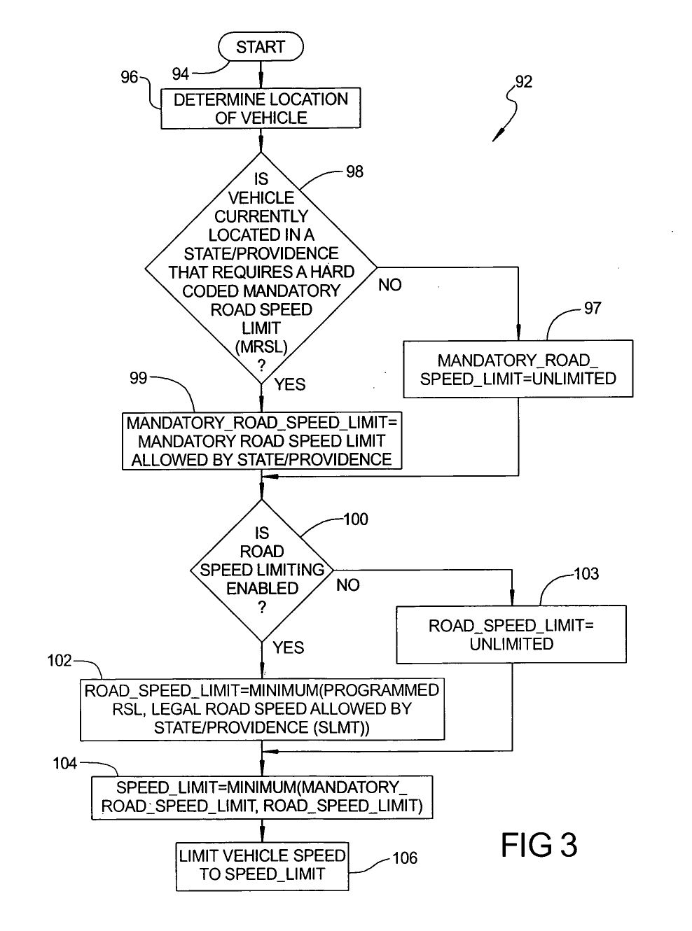

Turning to FIG. 3, a software flow diagram of one embodiment of the vehicle road speed limiting strategy of the present invention is generally illustrated and designated 92. Specifically, method 92 initiates with starting the engine at step 94. Step 96 is determining the geographical location of the engine or vehicle. This may be accomplished by the ECM receiving a signal from a Global Positioning satellite system setting forth the geographical location of the engine, or by means of a wireless signal received by the ECM setting forth the geographical location of the engine, or by means of a hand held device that inputs the geographical location of the vehicle, or by any other means such as may be known by those of ordinary skill in the art. Step 98 is determining whether the engine is currently in a geographical location that requires hard mandatory road speed limit in the operation of the engine. If the determination in step 98 is that the engine is not in a geographical location that requires a hard coded mandatory road speed limit, the mandatory road speed limit is unlimited as at step 97. If the determination is made that that the engine is located in a geographical location the requires a hard coded mandatory road speed limit, the method proceed to step 99, which is determining whether the hard coded mandatory road speed limit equal the mandatory road speed limit allowed by the geographical location in which the vehicle is located. Step 100 is determining whether the road speed limiting is enabled. If no, road speed is unlimited as at step 103 and the method proceeds to step 104. If yes, step 102 is determining whether the road speed limit equals the minimum programmed road speed limit allowed by the geographical location. If yes, step 104 is determining whether the speed limit equals the minimum or maximum road speed limit and step 106 is limiting the vehicle speed to the speed limit.

Those skilled in the art will understand that the terms used in this description are illustrative and are not intended to be limiting in any way to the scope of the invention. In addition, various modifications will become apparent to those skilled in the art without departing form the scope and spirit of the invention.

I claim:

1. A method for vehicle controlling an electronic control module equipped internal combustion engine vehicle road speed limiting to conform to requirements of a geographical location, comprising;
determining the geographical location of the engine;
determining whether the engine is located within a geographical location that requires mandatory road speed limiting;
determining the road speed limit in the geographical location;
determining whether the mandatory road speed limiting is enabled;
determining whether vehicle road speed equals a minimum programmed road speed limiting allowed by the geographical location;
determining whether a speed limit equals a minimum mandatory road speed limiting; and
limiting the vehicle road speed to the speed limit in the geographical location.

2. The method of claim 1, wherein the electronic control module is equipped with look up tables that contain data that may be used to determine the road speed limit permitted by any given geographical location.

3. The method of claim 1, wherein said geographical location of the engine is communicated to the electronic control module by wireless communication.

4. The method of claim 4, wherein said wireless communication is a global positioning satellite transmission signal.

5. The method of claim 1, wherein said geographical location of the engine is communicated to the electronic control module by a hand held device through an interface to the electronic control module.

6. The method of claim 1, wherein the mandatory road speed limit and the programmed road speed limit change dynamically.

7. The method of claim 1, wherein said power take off mode includes said auxiliary power mode.

8. The method of claim 1, wherein said geographical location is a state within the United States of America.

9. The method of claim 1, wherein the vehicle speed is limited by limiting the delivery of fuel to the engine.

10. The method of claim 1, further including determining whether the engine is loaded with auxiliary devices.

11. A system for controlling a compression ignition internal combustion engine installed in a vehicle to limit vehicle speed to conform to the requirements of a geographical location, comprising:
a vehicle speed sensor that provides an indication of vehicle speed;
an engine controller with tables containing fueling strategies; said controller in communication with the vehicle speed sensor, the accelerator sensor, a plurality of switches, various fueling strategies, and at least one sensor for determining engine load, the engine controller capable of receiving a communication indicating the geographical location of a vehicle and monitoring at least the vehicle speed sensor to determine vehicle speed and whether fuel is being requested; determining the geographical location of the vehicle; determining the fueling strategy that will conform the vehicle speed to the requirements of the geographical location, and limiting fuel delivery to the engine in accordance with said strategy.
